(19) United States
(12) Patent Application Publication
(10) Pub. No.: US 2025/0297806 A1
(43) Pub. Date: Sep. 25, 2025

(54) MULTI-SCALE TEST DEVICE FOR CRYSTALLIZATION PERFORMANCE OF HIGH-TEMPERATURE MELTS

(71) Applicant: Chongqing University, Chongqing (CN)

(72) Inventors: Xuewei LV, Chongqing (CN); Yongda LI, Chongqing (CN); Qingyu DENG, Chongqing (CN); Junjie ZENG, Chongqing (CN); Rui WANG, Chongqing (CN); Guishang PEI, Chongqing (CN); Renhao TIAN, Chongqing (CN); Ningyu ZHANG, Chongqing (CN)

(21) Appl. No.: 18/956,611

(22) Filed: Nov. 22, 2024

(30) Foreign Application Priority Data
Mar. 25, 2024 (CN) 202410340038.7

(51) Int. Cl. F27B 3/28; F27B 3/22; F27D 7/06; G01N 21/3577; G01N 21/84

(52) U.S. Cl. CPC F27B 3/28; F27B 3/22; F27D 7/06; G01N 21/3577; G01N 21/84; C21B 2300/04; C21C 2300/06; F27D 2007/066; G01N 2021/8477; G01N 2201/06113

(57) ABSTRACT

Provided is a multi-scale test device for crystallization performance of high-temperature melts, including a furnace body, an atmosphere control system, an optical path system, a temperature control system and a control display system. The furnace body includes furnace body includes a cavity, a thermocouple wire, a hot wire fixing block, a hot wire welding electrode, a reflecting surface, an air inlet pipe and an air outlet pipe. The thermocouple wire, the hot wire fixing block, the hot wire welding electrode and the reflecting surface are located in the cavity, the air inlet pipe and the air outlet pipe are in communication with the cavity. The thermocouple wire is connected with the hot wire welding electrode to form a heating wire structure onto which a sample is placed, and a center of the heating wire structure is located directly above the reflecting surface.

### CROSS-REFERENCE TO RELATED PRESENT DISCLOSURE

This patent application claims the benefit and priority of Chinese Patent Present disclosure No. 202410340038.7 filed with the China National Intellectual Property Administration on Mar. 25, 2024, the disclosure of which is incorporated by reference herein in its entirety as part of the application.

### TECHNICAL FIELD

The present disclosure relates to the technical field of testing crystallization performance of material melts, and in particular to a multi-scale test device for crystallization performance of high-temperature melts.

### BACKGROUND

The crystallization performance of materials is an important factor to control the quality of materials. Currently, test methods for melting crystallization performance of high-temperature melts include a thermal analysis method, a microscope hemisphere method, a quenching method, etc. However, the equipment cost of these methods is very expensive, and there are still some problems such as poor temperature control effects and inability to carry out in-situ observation.

In recent years, in order to achieve the in-situ observation in the characterization technology, a hot thermocouple technique for rapid cooling of high-temperature slags has appeared in the industry. The hot thermocouple technique uses a thermocouple wire as a heating element forming a miniature electric furnace and a temperature measuring unit, which has the advantages of being low in price, simple in operation, high in heating and cooling speed, small in constant temperature errors, strong in real-time performance and in-situ observable, solving the above problems well.

However, there are still problems in the existing equipment, such as inaccurate temperature control, complex circuit design, uneven temperature distribution and a single function. The key problem is that the hot thermocouple technique is only suitable for the characterization of crystallization performance of high-temperature transparent materials due to the limitation of an optical path and the process design. However, in the metallurgical industry, only the continuous casting slag is transparent at a high temperature, which greatly reduces the applicability of the hot thermocouple technique.

### SUMMARY

The objective of the present disclosure is to provide a multi-scale test device for crystallization performance of high-temperature melts, so as to solve the problem that it is difficult for the hot thermocouple technique proposed in the above background to be applied to the characterization of crystallization performance of materials other than high-temperature transparent materials.

In order to achieve the above objective, the present disclosure provides the following technical scheme. A multi-scale test device for crystallization performance of high-temperature melts is provided, including:
a furnace body, an atmosphere control system, an optical path system, a temperature control system and a control display system;
the furnace body includes a cavity, a thermocouple wire, a hot wire fixing block, a hot wire welding electrode, a reflecting surface, an air inlet pipe and an air outlet pipe, the thermocouple wire, the hot wire fixing block, the hot wire welding electrode and the reflecting surface are located in the cavity, the air inlet pipe and the air outlet pipe are in communication with the cavity, the thermocouple wire is connected with the hot wire welding electrode to form a heating wire structure onto which a sample is placed, and a center of the heating wire structure is located directly above the reflecting surface;
the temperature control system includes a temperature control board and a connecting wire, the temperature control board is connected with the thermocouple wire in the cavity through the connecting wire, and the temperature control board is connected with the control display system;
the atmosphere control system includes a gas cylinder and a control cabinet, a gas port of the gas cylinder is connected with an outer end of the air inlet pipe, a flowmeter and a gas valve are assembled on the gas port of the gas cylinder, a signal input end of the control cabinet is connected with the flowmeter, and a signal output end of the control cabinet is connected with the gas valve;
the optical path system includes a microscope, a laser source and a camera, an upper side of the cavity is provided with a furnace cover observation port, the microscope is provided at the furnace cover observation port, an eyepiece lens above the microscope is connected with the camera, an objective lens below the microscope is provided with a magnifying lens, the laser source is an infrared light source, the laser source is provided at the furnace cover observation port;
the control display system includes a controller and a display device, and the atmosphere control system, the optical path system and the temperature control system are in signal connection with the controller and the display device.

Preferably, a sealing gasket is provided at a position where the hot wire welding electrode and the cavity are connected.

Preferably, the sealing gasket is made of polytetrafluoroethylene and is located below the hot wire welding electrode.

Preferably, the cavity includes a furnace wall, a furnace bottom and a furnace cover, the furnace wall is hollow and has an upper opening and a lower opening, the furnace bottom is integrally formed with the furnace wall at the lower opening of the furnace wall, the furnace cover is detachably connected to the upper opening of the furnace wall, the hot wire fixing block and the hot wire welding electrode are fixed on the furnace bottom via screws, and the furnace cover observation port is provided on the furnace cover.

Preferably, the thermocouple wire is a platinum-rhodium wire with an arc structure, the thermocouple wire includes one or two thermocouple wires, and an upper side of the thermocouple wire is a sample placing area which is located in a center of the cavity.

Preferably, the atmosphere control system further includes a vacuum pump, a suction port of the vacuum pump is connected with an outer end of the air outlet pipe, an exhaust valve is provided at the suction port of the vacuum pump, a pressure sensor is provided on the air outlet pipe, the pressure sensor is connected with the signal input end of the control cabinet, and the signal output end of the control cabinet is connected with the vacuum pump and the exhaust valve.

Preferably, the camera is a high-speed color camera with high-temperature image optimization capability.

Preferably, the magnifying lens includes a plurality of magnifying lenses.

Preferably, a bottom of the cavity is punched with a round hole, and the connecting wire passes through the round hole.

Preferably, the reflecting surface is connected with the controller and the display device via a second connecting wire below the reflecting surface, so that an inclination angle of the reflecting surface is able to be adjusted by means of the controller and the display device to change an angle at which a laser light irradiates on the sample.

Compared with the prior art, the present disclosure has the following beneficial effects.

Using a platinum-rhodium thermocouple wire which integrates the functions of heating, loading samples and measuring temperatures, the heating and cooling rate is faster than that of conventional silicon-molybdenum rod type external heating in a reasonable operating system, a higher heating temperature can be obtained, and temperature detection can be carried out.

The device uses high brightness, monochromaticity, directionality and coherence of laser to achieve in-situ observation of translucent slag samples at a high temperature, and cooling crystallization information of the translucent samples can be known from photos.

The atmosphere control system of the device can simulate the atmospheric conditions such as oxidation and reduction atmosphere, reflect the actual metallurgical production and carry out multi-scale characterization of performance.

The multi-scale test device for crystallization performance of high-temperature melts is portable, small in sample capacity, and shorter in the experiment period, which meets the analysis and detection demand and is widely used in metallurgical slag experiments and crystallization performance researches.

### BRIEF DESCRIPTION OF THE DRAWINGS

FIG. 1 is a schematic structural diagram of the present disclosure.

FIG. 2 is a schematic structural diagram of a furnace body according to the present disclosure.

FIG. 3 is a schematic structural diagram of components in a cavity according to the present disclosure.

FIG. 4 is a schematic structural diagram of an optical path according to the present disclosure.

FIG. 5 is a high-temperature in-situ crystallization diagram of K₂SO₄.

In the figures: 1 Furnace body; 11 Furnace wall; 12 Furnace cover; 13 Furnace cover observation port; 14 Hot wire fixing block; 15 Thermocouple wire; 16 Hot wire welding electrode; 17 Reflecting surface; 18 Air inlet pipe; 19 Air outlet pipe; 2 Atmosphere control system; 3 Optical path system; 20 camera; 21 objective lens; 22 laser source; 23 eyepiece lens; 4 Temperature control system; and 5 Control display system.

### DETAILED DESCRIPTION OF THE EMBODIMENTS

The technical scheme in the embodiments of the present disclosure will be clearly and completely described with reference to the accompanying drawings in the embodiments of the present disclosure hereinafter. Obviously, the described embodiments are only some of the embodiments of the present disclosure, rather than all of the embodiments. Based on the embodiments of the present disclosure, all other embodiments obtained by those skilled in the art without creative effect belong to the scope of protection of the present disclosure.

In the description of the present disclosure, it should be understood that the orientation or position relationship indicated by the terms such as “upper”, “lower”, “front”, “rear”, “left”, “right”, “top”, “bottom”, “inner” and “outer” is the orientation or position relationship shown based on the accompanying drawings, which is only for the convenience of describing the present disclosure and simplifying the description, rather than indicates or implies that the referred devices or elements must have a specific orientation, be constructed and operated in a specific orientation. Therefore, it cannot be understood as limiting the present disclosure.

### Embodiment 1

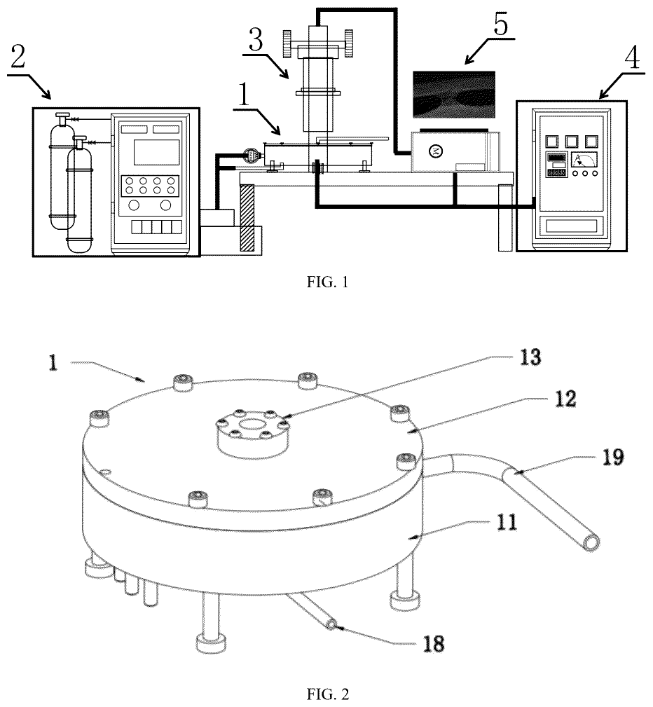

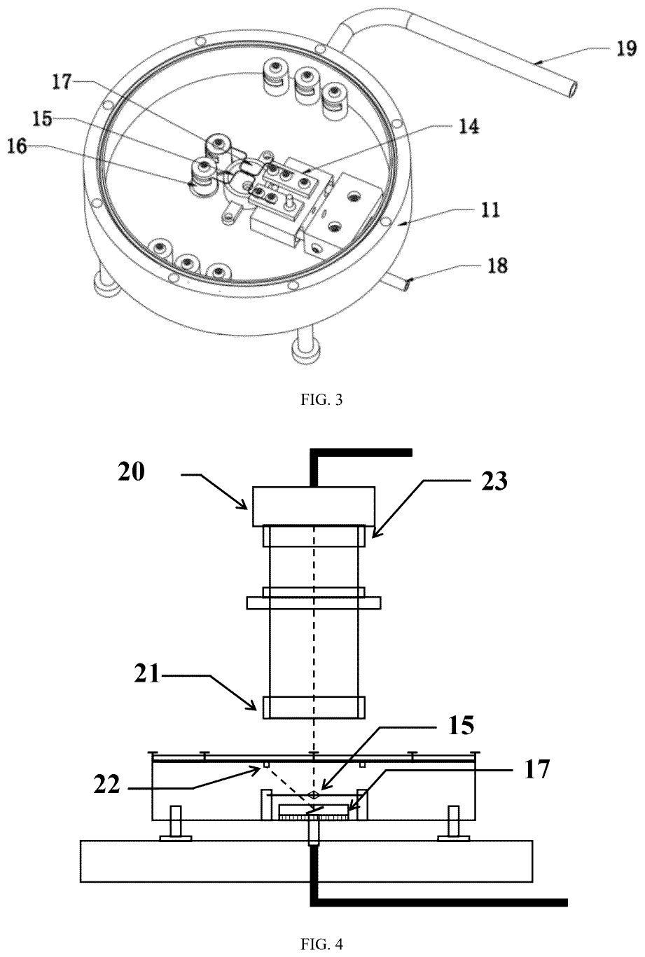

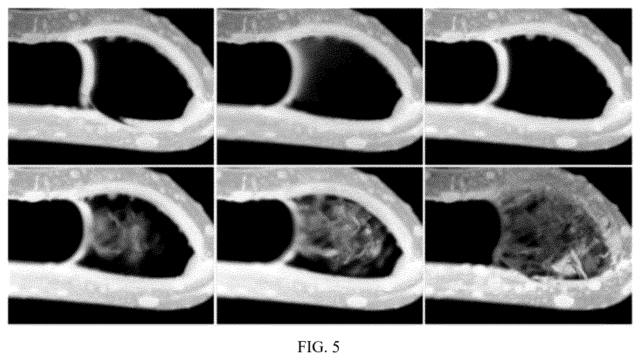

Referring to FIG. 1 to FIG. 4, the present disclosure provides a technical scheme. A multi-scale test device for crystallization performance of high-temperature melts includes a furnace body 1, an atmosphere control system 2, an optical path system 3, a temperature control system 4 and a control display system 5.

The furnace body 1 includes a cavity, a thermocouple wire 15, a hot wire fixing block 14, a hot wire welding electrode 16, a reflecting surface 17, an air inlet pipe 18 and an air outlet pipe 19. The thermocouple wire 15, the hot wire fixing block 14, the hot wire welding electrode 16 and the reflecting surface 17 are located in the cavity. The air inlet pipe 18 and the air outlet pipe 19 are in communication with the cavity. The thermocouple wire 15 is connected with the hot wire welding electrode 16 to form a heating wire structure onto which a sample is placed. The center of the heating wire structure is located directly above the reflecting surface 17. The temperature control system 4 includes a temperature control board and a connecting wire. The bottom of the cavity is punched with a round hole, and the connecting wire passes through the round hole. The temperature control board is connected with the thermocouple wire 15 in the cavity via the connecting wire, and the temperature control board is connected with the control display system 5. The atmosphere control system 2 includes a gas cylinder and a control cabinet. A gas port of the gas cylinder is connected with an outer end of the air inlet pipe 18. A flowmeter and a gas valve are assembled on the gas port of the gas cylinder. A signal input end of the control cabinet is connected with the flowmeter, and a signal output end of the control cabinet is connected with the gas valve. The optical path system 3 includes a microscope, a laser source 22, the reflecting surface 17 and a camera 20. An upper side of the cavity is provided with a furnace cover observation port 13. The microscope is provided at the furnace cover observation port 13. An eyepiece lens 23 above the microscope is connected with the camera 20. An objective lens 21 below the microscope is provided with a magnifying lens. A plurality of magnifying lenses are provided. The laser source 22 is an infrared light source. The laser source is provided at the furnace cover observation port 13. The reflecting surface 17 is connected with the control display system 5 via a connecting wire below the reflecting surface, so that the inclination angle of the reflecting surface 17 can be adjusted by means of the controller and the display device to change an angle at which a laser light irradiates on the sample. The control display system 5 includes a controller and a display device. The atmosphere control system 2, the optical path system 3 and the temperature control system 4 are in signal connection with the controller and the display device.

The analysis of the above content shows that: the temperature control board is connected with the hot wire welding electrode 16 via the connecting wire passing through the round hole at the bottom of the furnace body, so that the sample is heated with the heating of the thermocouple wire 15. The data output end of the thermocouple wire 15 is connected with the temperature control board. The temperature signal measured by the thermocouple wire is input to the temperature control board. The temperature control board adjusts the input voltage according to the received temperature signal to control the heating temperature of the thermocouple wire 15, thus achieving closed-loop control.

According to the demand of the experiment, in a case that the experiment is conducted in the corresponding atmosphere, the gas required by the atmosphere is pre-stored in the gas cylinder. The gas valve is turned on, and gas enters into the cavity through the air inlet pipe 18. The flow rate of gas is monitored in real time by the flowmeter and controlled in real time by the gas valve. The tail gas is output from the air outlet pipe 19.

A switch for the laser source is separately arranged outside the furnace body, which achieves the observation to translucent materials. The angle of the laser source 22 irradiates onto the reflecting surface 17 below the sample, the angle of the reflected laser is adjusted by means of the reflecting surface 17, so that the reflected laser irradiates on the experimental material, the crystallization behavior of materials is determined by difference in transmittance of high-temperature translucent material to laser. The camera 20 achieves the function of real-time photographing and observation, taking photos of the experimental process magnified by the microscope and transmitting photos to the control display system 5. The types and placement positions of laser sources can be customized and selected according to the types of materials, so as to achieve the purpose of real-time observation of translucent materials.

### Embodiment 2

Referring to FIG. 1 to FIG. 4, the present disclosure provides a technical scheme according to the Embodiment 1. A sealing gasket is provided at a position where the hot wire welding electrode 16 and the cavity are connected. The sealing gasket is made of polytetrafluoroethylene and is located below the hot wire welding electrode 16.

The analysis of the above content shows that: the sealing gasket is embedded at the position where the hot wire welding electrode 16 and the cavity are connected to ensure the tightness of the structure of the cavity.

### Embodiment 3

Referring to FIG. 1 to FIG. 4, the present disclosure provides a technical scheme according to Embodiment 1. The cavity includes a furnace wall 11, a furnace bottom and a furnace cover 12. The furnace wall 11 is hollow and has upper and lower openings. The furnace bottom is integrally formed with the furnace wall 11 at the lower opening of the furnace wall 11. The furnace cover 12 is detachably connected to the upper opening of the furnace wall 11. The hot wire fixing block 14 and the hot wire welding electrode 16 are fixed on the furnace bottom via screws. The furnace cover observation port 13 is provided on the furnace cover 12.

The analysis of the above content shows that: a sealed structure is formed between the furnace wall 11, the furnace bottom and the furnace cover 12, and the furnace cover observation port 13 is configured for observing the reaction conditions in the cavity by means of the microscope and the camera.

### Embodiment 4

Referring to FIG. 1 to FIG. 4, the present disclosure provides a technical scheme according to Embodiment 1. The thermocouple wire 15 is a platinum-rhodium wire with an arc structure. One thermocouple wire 15 or two thermocouple wires 15 are provided. An upper side of the thermocouple wire 15 is a sample placing area which is located in the center of the cavity. In a case that there is one thermocouple wire 15, the heating wire structure is a single-wire heating structure. In a case that there are two thermocouple wires 15, the heating wire structure is a double- wire heating structure.

The analysis of the above content shows that: the platinum-rhodium thermocouple wire used as a temperature measuring sensor is usually used in conjunction with a temperature transmitter, a regulator and a display instrument to form a process control system, which is used to directly measure or control the temperatures of fluid, steam and gas media and solid surfaces within the range of 0° C. to 1700° C. in various production processes. While, the platinum-rhodium thermocouple wire can also be used as a heating device in the scheme.

### Embodiment 5

Referring to FIG. 1 to FIG. 4, the present disclosure provides a technical scheme according to Embodiment 1. The atmosphere control system 2 further includes a vacuum pump. A suction port of the vacuum pump is connected with an outer end of the air outlet pipe 19. An exhaust valve is provided at the suction port of the vacuum pump. A pressure sensor is provided on the air outlet pipe 19. The pressure sensor is in communication with the air outlet pipe 19 and can detect the pressure in the air outlet pipe 19 and the cavity. The pressure sensor is connected with the signal input end of the control cabinet, and the signal output end of the control cabinet is connected with the vacuum pump and the exhaust valve.

The analysis of the above content shows that: the vacuum pump is in communication with the furnace body 1 via the air outlet pipe 19 for vacuumizing. The signal input end of the control cabinet is connected with the pressure sensor while the signal output end of the control cabinet is connected with the gas valve and the vacuum pump, so as to control vacuumizing and gas mixing. The control cabinet controls the vacuumizing process by controlling the on-off and the operating time of the vacuum pump. The vacuum control and the control of control cabinet to the vacuum pump belong to the prior art and do not belong to the inventive part of the present disclosure. The vacuum pump vacuumizes the furnace body to speed up the ventilation rate in the furnace body. Thereafter, protective gas, such as argon, is introduced into the furnace body 1 through the gas cylinder until the furnace body reaches the target pressure and is balanced.

### Embodiment 6

Referring to FIG. 1 to FIG. 4, the present disclosure provides a technical scheme according to Embodiment 1. The camera is a high-speed color camera with high-temperature image optimization capability to ensure real-time characterization in high-temperature conditions.

The specific working process of the test device is as follows.

S1: the sample meeting the test requirements is prepared (the sample is usually mixed with powder raw materials and alcohol and in a viscous state, which is convenient to be carried on the heating wire structure), and the sample to be tested is evenly spread on the arc structure area of the thermocouple wire 15.

S2: the vacuum pump is turned on to vacuumize the furnace body 1, and then argon or nitrogen protective gas is continuously introduced into the furnace body at a fixed flow rate and a micro-positive pressure in the furnace body is kept, in order to ensure a better test environment in the furnace body.

The atmosphere control system is started, the required gas in the experiment is prepared and mixed, and is continuously introduced into the furnace body at a fixed flow rate to meet the test conditions of the experiment.

S3: the optical path system and the control display system are started, and the focal distance is adjusted to obtain the field of view of the sample to be tested, ensuring that the display displays the photos of the sample in real time.

S4: the temperature control system is started, the experiment slag is heated to the specified temperature to melt the slag, the melting uniformity of the slag is observed by means of the display, and the temperature change data of the slag is measures by means of the thermocouple wire.

S5: the temperature control system sets the range of crystallization temperature to be measured, the camera is controlled to take a photo at regular intervals, the experiment enters the cooling stage, and the sample temperature, time and high-temperature crystallization photos are recorded in real time.

For high-temperature translucent materials, the following operations are supplemented before the experiment enters the cooling stage: the laser source is started, the angle of the reflecting surface is adjusted to change the position of the laser light, the crystallization performance of the sample is characterized through the degree to which the laser transmits through the material, ensuring the laser visualization of translucent materials.

S6: the temperature control system, the atmosphere control system and the optical path system are turned off after the experiment is completed, and the test sample is cleaned after the thermocouple wire is cooled to the room temperature.

In order to understand the above working process of the present disclosure better, the operation of test for crystallization performance of slags will be explained with reference to a specific example hereinafter.

### Example 1

K₂SO₄ was selected as the sample. The experiment of characterization of crystallization performance was carried out according to the above working process. The whole experiment lasted for 5 minutes. A high-temperature in-situ crystallization photos of K₂SO₄ are shown in FIG. 5. It can be seen from FIG. 5 that the real-time photos have a high resolution, and the crystallization behavior of the sample can be observed in situ, which meets the experimental demands of characterization of crystallization performance of slags.

The experiment performed by the device has a short period, not only can test the crystallization performance of transparent/translucent samples, but also carry out multi-component atmosphere reaction experiments to simulate the actual production environment. The precision of the device can also meet the test requirements.

The basic principles, the main features and the advantages of the present disclosure have been shown and described above. It is obvious to those skilled in the art that the present disclosure is not limited to the details of the above exemplary embodiments, but can be achieved in other specific forms without departing from the spirit or basic features of the present disclosure. Therefore, the embodiments should be considered as exemplary and non-limiting in all aspects. The scope of the present disclosure is defined by the appended claims rather than the above description. Therefore, it is intended to embrace all changes that fall within the meaning and the range of equivalents of the claims in the present disclosure. Any reference signs in the claims should not be construed as limiting the claims concerned.

Although embodiments of the present disclosure have been shown and described, it will be understood by those skilled in the art that various changes, modifications, substitutions and variations can be made to these embodiments without departing from the principle and the spirit of the present disclosure. The scope of the present disclosure is defined by the appended claims and their equivalents.

What is claimed is:

1. A multi-scale test device for crystallization performance of high-temperature melts, comprising:
a furnace body, an atmosphere control system, an optical path system, a temperature control system and a control display system;
wherein the furnace body comprises a cavity, a thermocouple wire, a hot wire fixing block, a hot wire welding electrode, a reflecting surface, an air inlet pipe and an air outlet pipe, wherein the thermocouple wire, the hot wire fixing block, the hot wire welding electrode and the reflecting surface are located in the cavity, the air inlet pipe and the air outlet pipe are in communication with the cavity, the thermocouple wire is connected with the hot wire welding electrode to form a heating wire structure onto which a sample is placed, and a center of the heating wire structure is located directly above the reflecting surface;
the temperature control system comprises a temperature control board and a first connecting wire, wherein the temperature control board is connected with the thermocouple wire in the cavity via the first connecting wire, and the temperature control board is connected with the control display system;
the atmosphere control system comprises a gas cylinder and a control cabinet, wherein a gas port of the gas cylinder is connected with an outer end of the air inlet pipe, a flowmeter and a gas valve are assembled on the gas port of the gas cylinder, a signal input end of the control cabinet is connected with the flowmeter, and a signal output end of the control cabinet is connected with the gas valve;
the optical path system comprises a microscope, a laser source, the reflecting surface and a camera, wherein an upper side of the cavity is provided with a furnace cover observation port, the microscope is provided at the furnace cover observation port, an eyepiece lens above the microscope is connected with the camera, an objective lens below the microscope is provided with a magnifying lens, the laser source is an infrared light source, the laser source is provided at the furnace cover observation port;
the control display system comprises a controller and a display device, and the atmosphere control system, the optical path system and the temperature control system are in signal connection with the controller and the display device.

2. The multi-scale test device for crystallization performance of high-temperature melts according to claim 1, wherein a sealing gasket is provided at a position where the hot wire welding electrode and the cavity are connected.

3. The multi-scale test device for crystallization performance of high-temperature melts according to claim 2, wherein the sealing gasket is made of polytetrafluoroethylene and is located below the hot wire welding electrode.

4. The multi-scale test device for crystallization performance of high-temperature melts according to claim 1, wherein the cavity comprises a furnace wall, a furnace bottom and a furnace cover, the furnace wall is hollow and has an upper opening and a lower opening, the furnace bottom is integrally formed with the furnace wall at the lower opening of the furnace wall, the furnace cover is detachably connected to the upper opening of the furnace wall, the hot wire fixing block and the hot wire welding electrode are fixed on the furnace bottom via screws, and the furnace cover observation port is provided on the furnace cover.

5. The multi-scale test device for crystallization performance of high-temperature melts according to claim 1, wherein the thermocouple wire is a platinum-rhodium wire with an arc structure, the thermocouple wire comprises one or two thermocouple wires, and an upper side of the thermocouple wire is a sample placing area which is located in a center of the cavity.

6. The multi-scale test device for crystallization performance of high-temperature melts according to claim 1, wherein the atmosphere control system further comprises a vacuum pump, a suction port of the vacuum pump is connected with an outer end of the air outlet pipe, an exhaust valve is provided at the suction port of the vacuum pump, a pressure sensor is provided on the air outlet pipe, the pressure sensor is connected with the signal input end of the control cabinet, and the signal output end of the control cabinet is connected with the vacuum pump and the exhaust valve.

7. The multi-scale test device for crystallization performance of high-temperature melts according to claim 1, wherein the camera is a high-speed color camera with high-temperature image optimization capability.

8. The multi-scale test device for crystallization performance of high-temperature melts according to claim 1, wherein the magnifying lens comprises a plurality of magnifying lenses.

9. The multi-scale test device for crystallization performance of high-temperature melts according to claim 1, wherein a bottom of the cavity is punched with a round hole, and the first connecting wire passes through the round hole.

10. The multi-scale test device for crystallization performance of high-temperature melts according to claim 1, wherein the reflecting surface is connected with the controller and the display device via a second connecting wire below the reflecting surface, so that an inclination angle of the reflecting surface is able to be adjusted by means of the controller and the display device to change an angle at which a laser light irradiates on the sample.

11. The multi-scale test device for crystallization performance of high-temperature melts according to claim 1, wherein the laser source is provided below the furnace cover observation port.
